(19) United States
(12) Patent Application Publication
(10) Pub. No.: US 2020/0230548 A1
(43) Pub. Date: Jul. 23, 2020

(54) CARBON CAPTURE TOWER

(71) Applicant: Evapco, Inc., Taneytown, MD (US)

(72) Inventor: Jean-Pierre Libert, Frederick, MD (US)

(21) Appl. No.: 16/751,113

(22) Filed: Jan. 23, 2020

Related U.S. Application Data
(60) Provisional application No. 62/795,865, filed on Jan. 23, 2019.
(60) Provisional application No. 62/829,384, filed on Apr. 4, 2019.

(51) Int. Cl. B01D 53/62; B01D 53/78

(52) U.S. Cl. CPC B01D 53/62; B01D 53/78; B01D 2251/304; B01D 2258/06; B01D 2251/604; B01D 2257/504; B01D 2251/306

(57) ABSTRACT

A device and method for removing carbon dioxide from the air including a reaction unit containing a fluid dispersion medium such as fill, a reaction fluid distribution system for distributing sodium or potassium hydroxide over the fluid dispersion medium, and an air mover for drawing or forcing air into the reaction unit to contact the sodium or potassium hydroxide. Carbon dioxide in the air reacts with the potassium or sodium hydroxide to form potassium or sodium carbonate, thus removing carbon dioxide from the air. The device may include humidifiers to humidify the ambient air before it contacts the reaction fluid.

### BACKGROUND OF THE INVENTION

### Field of the Invention

The present invention relates to methods and devices for removing carbon dioxide from the air.

### SUMMARY OF THE INVENTION

The present invention is a device/system for removing carbon dioxide from the air. The device may be used to ameliorate the effect of greenhouse and/or for the purpose of collecting carbon for conversion to a fuel source. The device works by reacting ambient air, humidified or non-humidified, with potassium or sodium hydroxide to form potassium or sodium carbonate.

### Carbon Capture Combined Crossflow/Counterflow Device

According to a first embodiment of the invention, a central reaction unit is flanked by saltwater humidifiers.

An air mover is preferably located atop the central reaction unit to draw air through the side of the humidifiers (crossflow), into a plenum of the central reaction unit, and up and out the top of the device (counter-flow).

ArchBar brand splash fill or another appropriate splash fill is stacked within the humidifiers. Any splash fill medium is suitable for use in the humidifier, but preferably having a structure configured to break up an aqueous solution into small droplets (preferably of a diameter of 10 mm or less, and more preferably 6 mm or less) while keeping the interacting air-side pressure drop as low as possible (preferably less than 250 Pa). A salt-water distribution system (preferably including header and spray nozzles or similar arrangement) is located at the top of the humidifiers to spray salt water over the splash fill. The salt water collects in a salt-water basin at the bottom of the humidifiers and is pumped via pump and recirculation pipes back to the top of the unit for re-distribution over the splash fill.

Ambient air passes through the humidifier, over the splash fill, and the humidified air is drawn up through the plenum of the reaction unit by the fan.

Another spray header is located in the central reaction unit beneath the fan. Potassium or sodium hydroxide is pumped to the spray header and is sprayed over approximately 6-20 feet of dense fill, such as Evapco's EvaPak brand film fill. Any film fill is suitable for use in the reaction unit, provided that it provides a support media to the aqueous solution to spread out in a thin film which results in a high contact area with the interacting ambient air, but preferably has a surface area to volume ratio of at least 124 square meters per cubic meter (38 ft²/ft³), and more preferably at least 210 m²/m³ (64 ft²/ft³), while keeping the interacting air-side pressure drop as low as possible (preferably less than 250 Pa).

When the ambient air contacts potassium or sodium hydroxide, a chemical reaction causes mass transfer of the carbon dioxide from the air to bond with the potassium or sodium hydroxide to form potassium or sodium carbonate and water. The dense fill helps to foster the chemical reaction because the potassium or sodium hydroxide adheres to the fill for a short time where it can contact the air to induce the reaction.

The resulting potassium or sodium carbonate and unreacted hydroxide (if any), which remains in liquid form, drops to the central unit basin and is then pumped out of the unit for use, further processing and/or disposal, as appropriate.

Highly efficient drift eliminators may be installed over the spray system to minimize the entrainment of liquid droplets to the atmosphere.

The device is typically field-erected to get large size desired for scale, but could be smaller.

The device features a fiberglass structure and panels/sheathing, fiberglass fans, and basins made of 316 stainless steel or another metal sufficiently resistant to the corrosive effects of seawater, highly caustic hydroxide and carbonate solutions, or reinforced concrete.

### Counterflow Carbon Capture Device

According to another embodiment of the invention, a central reaction unit (the air contactor) includes an air mover preferably located atop the central unit to draw air through the bottom side of the central unit into a plenum of the central unit, and up and out the top of the device (counterflow).

VertiClean brand film fill or another appropriate film fill is stacked within the central reaction unit. Any film fill is suitable for use in the reaction unit provided that it provides a support media to the aqueous solution to spread out in a thin film which results in a high contact area with the interacting ambient air. Ambient air is drawn up through the plenum of the air contactor by the fan.

A spray header is located in the central reaction unit beneath the fan. Potassium or sodium hydroxide is pumped to the spray header and is sprayed over approximately 6-40 feet of dense fill, such as Evapco's VertiClean brand fill.

When the ambient air contacts the potassium or sodium hydroxide a chemical reaction causes mass transfer of the carbon dioxide from the air to bond with the potassium or sodium hydroxide to form potassium or sodium carbonate and water. The dense fill helps to foster the chemical reaction because the potassium or sodium hydroxide adheres to the fill for a short time where it can contact the air to induce the reaction. The resulting potassium or sodium carbonate and unreacted hydroxide (if any), which remains in liquid form, drops to the central unit basin and is then pumped out of the unit for use, further processing and/or disposal, as appropriate.

Highly efficient drift eliminators are preferably installed over the spray system to minimize the entrainment of liquid droplets to the atmosphere.

The device is typically field-erected to get large size desired for scale, but could be smaller.

The device features a fiberglass structure and panels/sheathing, fiberglass fans, and basins made of 316 stainless steel (or another metal sufficiently resistant to the corrosive effects of highly caustic hydroxide and carbonate solutions) or reinforced concrete.

### Crossflow Carbon Capture Device

According to yet another embodiment of the invention, a central plenum unit is flanked by preferably two reaction units.

The central plenum unit includes an air mover preferably located atop the central plenum unit to draw air through the sides of the unit into the central plenum, and up and out the top of the device.

7500XF or 12500XF brand film fill or another appropriate film fill is stacked within the reaction units flanking the central plenum. Any film fill may be used provided that it provides a support media to the aqueous solution to spread out in a thin film which results in a high contact area with the interacting ambient air, and preferably has a surface area to volume ratio of at least 210 m²/m³ (64 ft²/ft³), while keeping the interacting air-side pressure drop as low as possible (preferably less than 250 Pa). Ambient air is drawn through the reaction units (the air contactors) then up through the central plenum by the fan.

A potassium or sodium hydroxide distribution system (preferably including header and spray nozzles or similar arrangement) is located at the top of the reaction units to spray hydroxide over the film fill. The potassium or sodium hydroxide is pumped to the spray header and is sprayed over approximately 6-40 feet of dense fill, such as Evapco's 7500XF or 12500XF brand film fill.

When the ambient air contacts the potassium or sodium hydroxide a chemical reaction causes mass transfer of the carbon dioxide from the air to bond with the potassium or sodium hydroxide to form potassium or sodium carbonate and water. The dense fill helps to foster the chemical reaction because the potassium or sodium hydroxide adheres to the fill for a short time where it can contact the air to induce the reaction. The resulting potassium or sodium carbonate and unreacted hydroxide (if any), which remains in liquid form, drops to the reaction unit basin and is then pumped out of the unit for use, further processing and/or disposal, as appropriate.

Highly efficient drift eliminators are installed after the spray system and stacked film fill to minimize the entrainment of liquid droplets to the atmosphere.

The device is typically field-erected to get large size desired for scale, but could be smaller.

The device features a fiberglass structure and panels/sheathing, fiberglass fans, and basins made of 316 stainless steel (or another metal sufficiently resistant to the corrosive effects of highly caustic hydroxide and carbonate solutions) or reinforced concrete.

Accordingly, there is provided according to the invention a carbon capture tower configured for large-scale and continuous removal of carbon dioxide from ambient air having a tower frame located above a reaction fluid basin, a fluid dispersion medium supported in the tower frame; a reaction fluid distribution system located in the tower frame and above the fluid dispersion medium and configured to distribute a reaction fluid over the fluid dispersion medium; a fan supported by the tower frame and configured to draw or force ambient air through the fluid dispersion medium as the reaction fluid distribution system is distributing the reaction fluid over the fluid dispersion medium; wherein the reaction fluid basin located beneath the tower frame is configured to catch a reaction product from a reaction between said reaction fluid and carbon dioxide in the ambient air as well as unreacted reaction fluid.

There is further provided according to an embodiment of the invention a carbon capture tower as described above wherein the reaction fluid distribution system and the fluid dispersion medium are located beneath said fan.

There is further provided according to an alternative embodiment of the invention a carbon capture tower wherein the tower frame defines a plenum beneath the fluid dispersion media, the carbon capture tower further including two humidifier sections of the tower frame flanking the plenum, the two humidifier sections each including water dispersion media supported in the frame and a saltwater distribution system located over the water dispersion media.

There is further provided according to an alternative embodiment of the invention a carbon capture tower wherein the tower frame defines a plenum beneath a diameter of the fan, and wherein the reaction fluid distribution system and the fluid dispersion medium are supported in a reaction portion of said tower frame that is laterally adjacent to the plenum.

There is further provided according to an alternative embodiment of the invention a carbon capture tower including a humidifier section of the tower frame that is laterally adjacent to the reaction portion of the tower frame on a side of the reaction portion of the tower frame that is opposite the plenum, each humidifier section of the tower frame including water dispersion media supported in the frame and a saltwater distribution system located over the water dispersion media.

There is further provided according to an alternative embodiment of the invention a carbon capture tower wherein the reaction fluid distribution system includes comprises a reaction fluid header connected to reaction fluid distribution pipes having spray nozzles connected thereto.

There is further provided according to a preferred embodiment of the invention a carbon capture tower wherein the reaction fluid is selected from the group consisting of sodium hydroxide, potassium hydroxide, and combinations thereof. There is further provided according to a preferred embodiment of the invention a carbon capture tower in which the tower frame and fan are fiberglass, and the basins are hydroxide and carbonate corrosion resistant metal or reinforced concrete. There is further provided according to the invention a carbon capture tower in which the fluid dispersion medium is film fill, preferably having a surface area to volume ratio of 124 square meters per cubic meter (38 ft2/ft3) or greater, and more preferably of 210 m2/m3 (64 ft2/ft3) or greater. There is further provided according to the invention a carbon capture tower in which the water dispersion medium is splash fill.

Additional features and details of the device may be seen in the following drawings.

### BRIEF DESCRIPTION OF THE DRAWINGS

FIG. 1 is a cross-sectional side view of a carbon capture tower according to a first embodiment of the invention.

FIG. 2 is a cross-sectional front view of a carbon capture tower according to the embodiment shown in FIG. 1.

FIG. 3 is a schematic plan view of a carbon capture tower according to a second embodiment of the invention.

FIG. 4 is a cross-section elevation view of a carbon capture tower according to the embodiment of FIG. 3.

FIG. 5 is an endwall elevation view of a carbon capture tower according to the embodiment of FIGS. 3 and 4.

FIG. 6 is a schematic plan view of a carbon capture tower according to a third embodiment of the invention.

FIG. 7 is a cross section elevation view of a carbon capture tower according to the embodiment of FIGS. 6.

FIG. 8 is an endwall elevation view of a carbon capture tower according to the embodiment of FIGS. 6 and 7.

FIG. 9 is a cross-section elevation view of a carbon capture tower according to a fourth embodiment of the invention.

FIG. 10 is a cross-section elevation view of a carbon capture tower according to a fifth embodiment of the invention.

FIG. 11 is a representative plan view of the embodiment shown in FIG. 10.

Features in the attached drawings are numbered with the following reference numerals:

| | | | |
|---|---|---|---|
| 1 | Carbon capture tower module | 21 | Salt water basin |
| 3 | Reaction unit | 23 | Salt water circulation pumps |
| 4 | Air inlet | 25 | KNa Hydroxide distribution |
| 5 | Saltwater humidifiers | | system |
| 7 | Air mover/fan | 27 | Riser |
| 9 | Inlet louvers | 29 | Feed pipe |
| 11 | Plenum | 31 | KNa Hydroxide Header |
| 13 | Splash Fill | 33 | KNa Hydroxide spray nozzles |
| 15 | Salt water distribution system | 35 | KNa Carbonate basin |
| 17 | Salt water header | 37 | Dense/Film Fill |
| 19 | Salt water spray nozzles | 39 | Drift Eliminators |
| 47 | Fan shroud | 43 | Salt water supply pipe |
| 49 | Fan deck | 53 | Corrugated sheathing/casing |
| 51 | Safety railing | 55 | Stairway |

### DETAILED DESCRIPTION

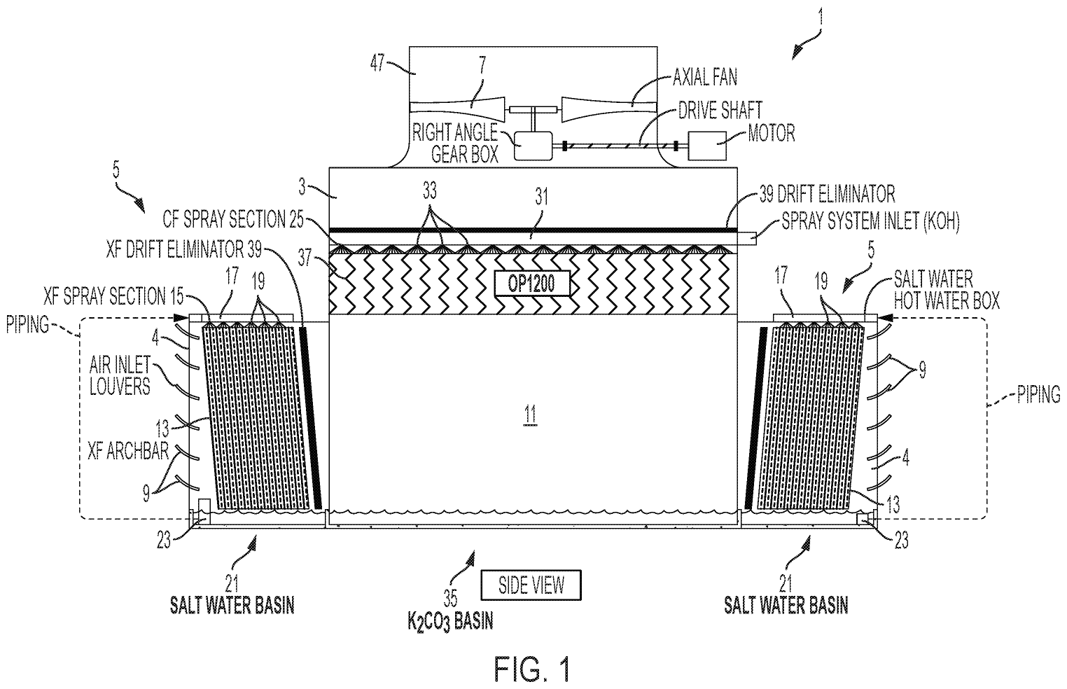

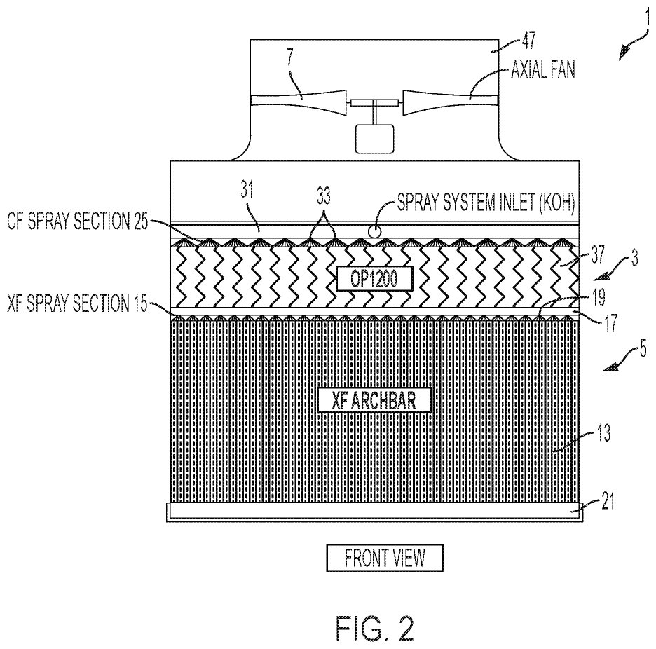

A first exemplary embodiment of the invention is shown in FIGS. 1 and 2. Carbon capture tower 1 of this embodiment features a reaction unit 3 centrally located and flanked by saltwater humidifiers 5. A fan 7 or other air mover is situated atop the reaction unit 3 to draw air through air inlets 4 in the side of the humidifiers 5 via air inlet louvers 9 and into the plenum 11.

The humidifiers 5 are provided with splash fill 13, and a saltwater distribution system 15 is located above the splash fill 13. The salt water distribution system 15 includes salt water header 17 and salt water spray nozzles 19, although any type of distribution system may be used. The bottom of the humidifiers 5 features a salt water basin 21 where the salt water distributed by the salt water distribution system 15 collects and is then pumped back to the salt water distribution system with salt water pump 23.

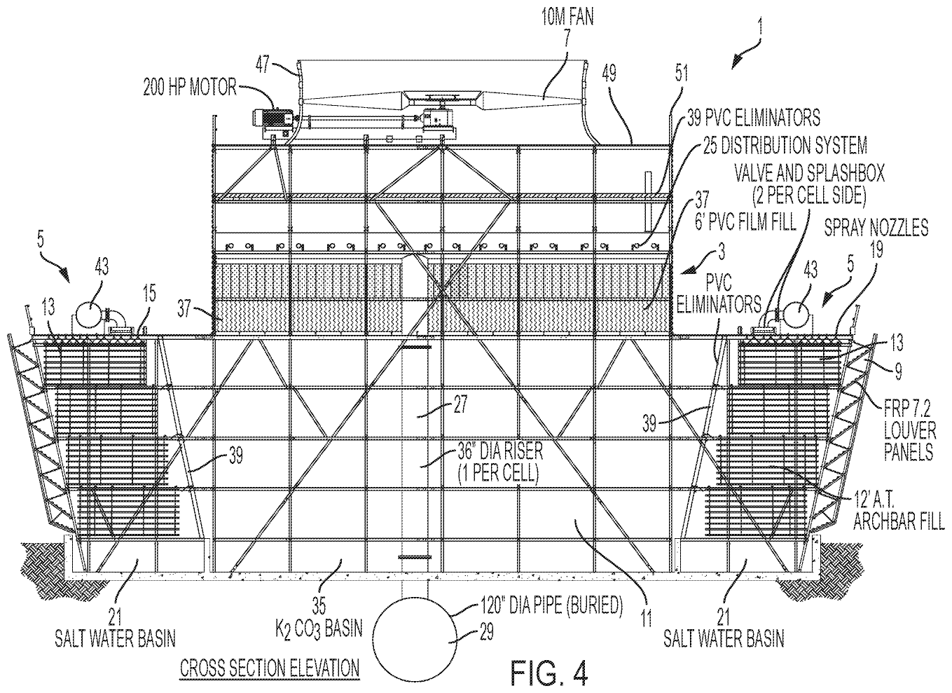

The reaction unit 3 includes plenum 11, which is laterally adjacent to the flanking humidifiers 5, over top which is situated a section of dense/film fill 37. A reaction fluid distribution system 25 is located above the section of dense fill 37 for distributing a reaction fluid over the dense fill. The reaction fluid is preferably sodium hydroxide or potassium hydroxide. The reaction fluid distribution system 25 includes header 31 and spray nozzles 33. The reaction fluid distribution system is fed by riser 27 from feed pipe 29 (See, e.g., FIG. 4).

The fan 7 draws air through the splash fill 13 in the humidifier sections 5 as the fill is wetted by the salt water distribution system 15; the air drawn by the fan then passes into the plenum 11 and up through the dense fill 37 that is wetted by the reaction fluid distribution system 25 and out the top of the device. When the ambient air, humidified by the humidifiers 5, contacts the reaction fluid in the dense fill section of the reaction unit 3, a chemical reaction causes a mass transfer of carbon dioxide in the air to bond with the potassium or sodium to form potassium carbonate or sodium carbonate and water. The resulting potassium carbonate or sodium carbonate and any unreacted reaction fluid falls into the central basin 35 for further processing or disposal. Drift eliminators 39 are situated between the splash fill 13 of the humidifiers 5 and the plenum 11 as well as above the reaction fluid distribution system 25.

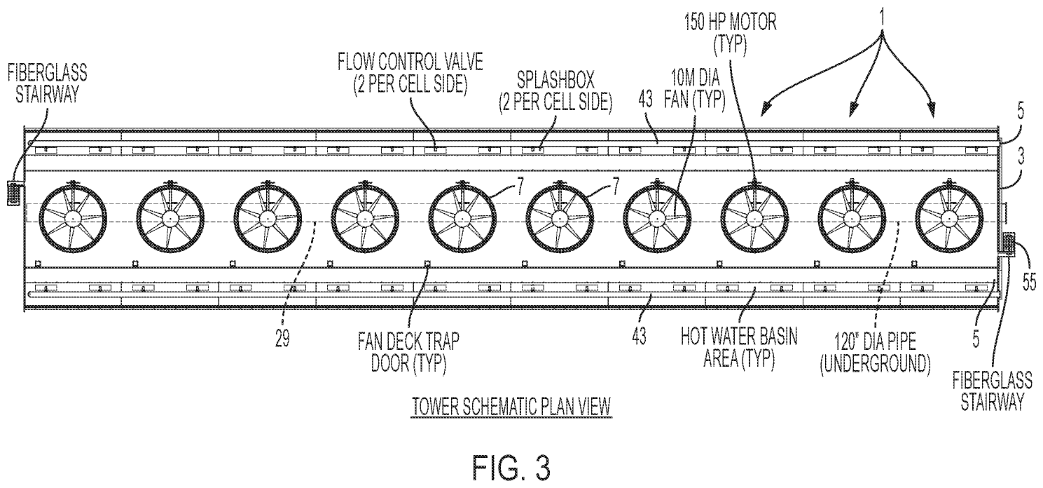

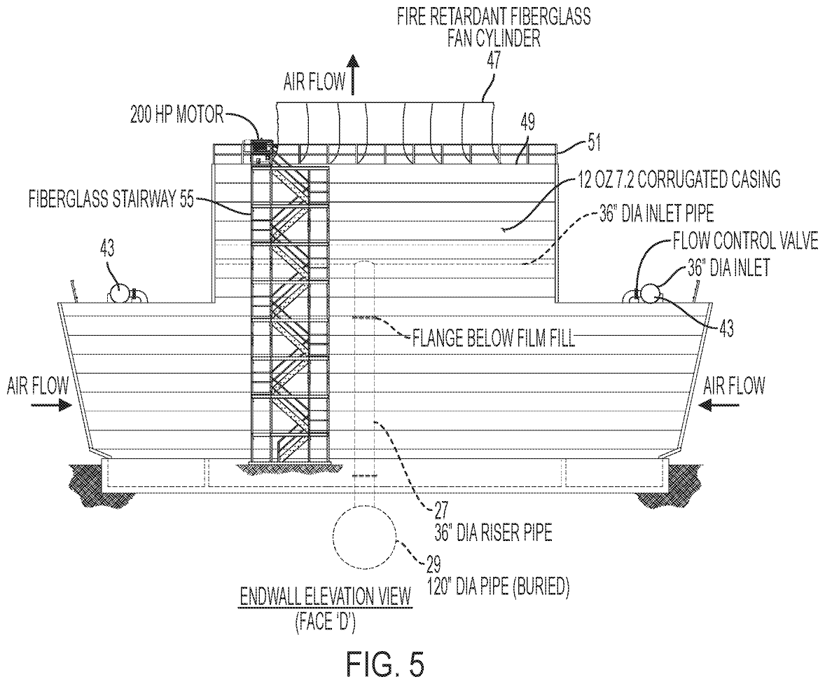

The device shown in FIGS. 1 and 2 is an individual module or “cell” containing a single reaction unit, which may be used standalone, or together with a plurality of other cells, according to the embodiment shown in FIGS. 3 through 5. According to the embodiment of FIGS. 3 through 5, the salt water basins 21 and the reaction fluid basin 35 each run the length of the plurality of cells. Additionally, a salt water supply pipe 43 runs along the top of each humidifier section providing salt water to the salt water distribution systems 15 of each cell. A reaction fluid supply pipe 29 is buried beneath the longitudinal axis of the center basin 35, and feeds reaction fluid to the reaction fluid distribution system 25 via riser 27. As shown in FIG. 5, the fan 7 is enclosed by a fan cylinder or shroud 47, the fan deck 49 is enclosed with a safety railing 51, the outside of the unit is clad in corrugated casing 51, and a stairway 55 may be provided to permit service access to the top of the unit.

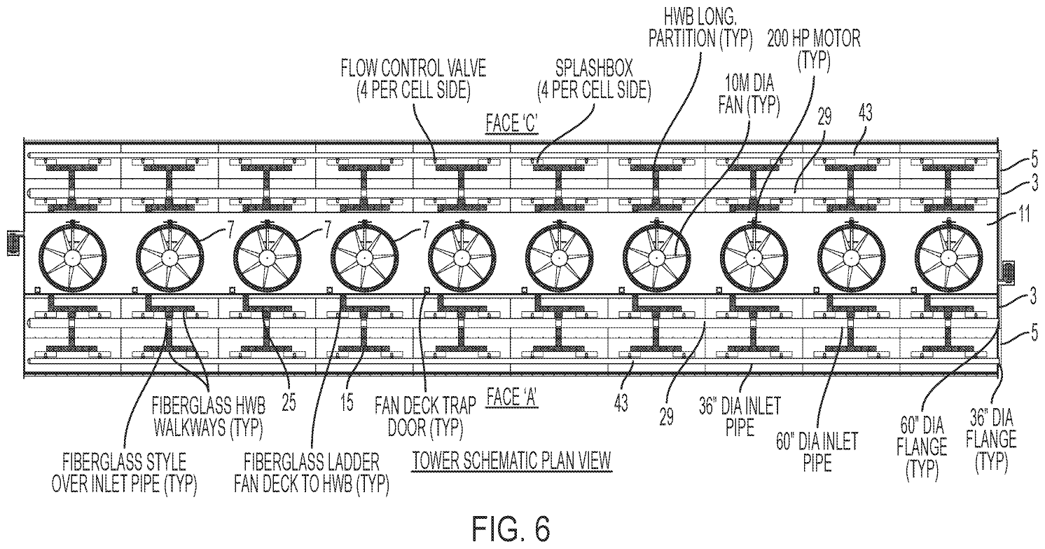

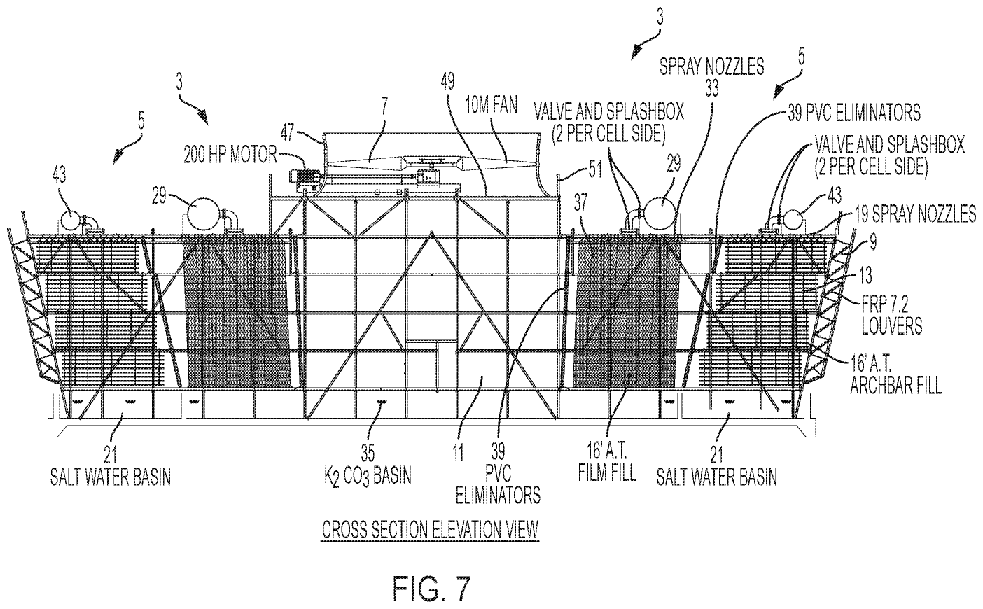

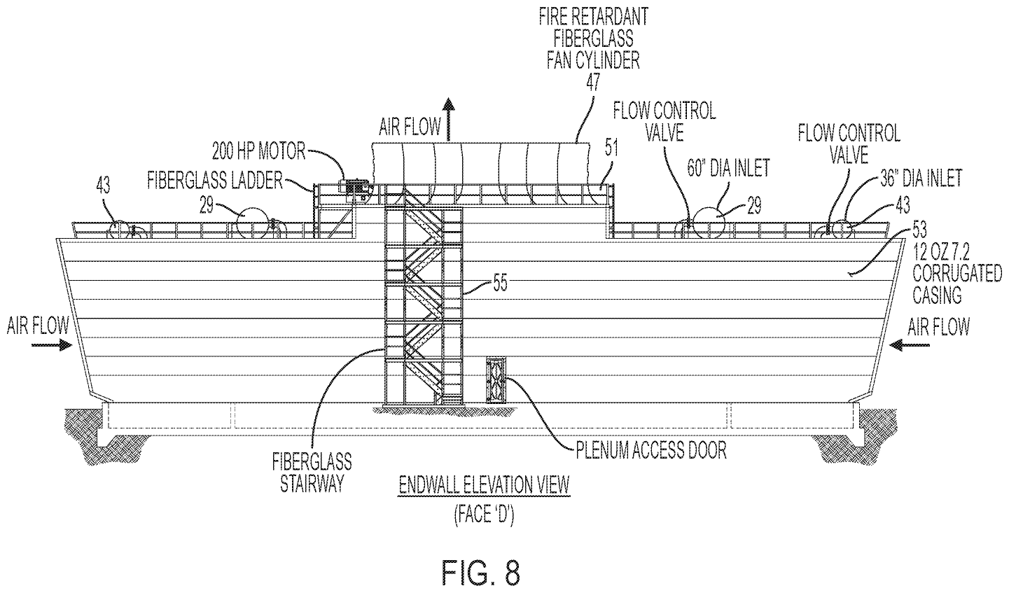

FIGS. 6-8 show a further alternative embodiment of the invention in which the reaction unit 3 of each cell is provided laterally between the plenum 11 and the humidifiers 5, rather than above the plenum 11 and directly below the fan 7 as shown in FIGS. 1-5. According to this embodiment, an elongated reaction fluid basin 35 is flanked by two elongated salt water basins 21. The plena 11 of a plurality of carbon capture cells are centered over the longitudinal axis of the reaction fluid basin. According to a preferred embodiment, the plena 11 of a plurality of cells are separated by a partition wall between each cell. Two reaction units 3 flank each plenum 11, and are located above lateral sections of the reaction fluid basin 35. A reaction fluid supply pipe 29 runs along the top of each row of reaction units 3 and provides reaction fluid to the reaction fluid distribution system 25 of each reaction unit. A salt water supply pipe 43 runs along the top of each humidifier section 5 providing salt water to the salt water distribution systems 15 of each cell.

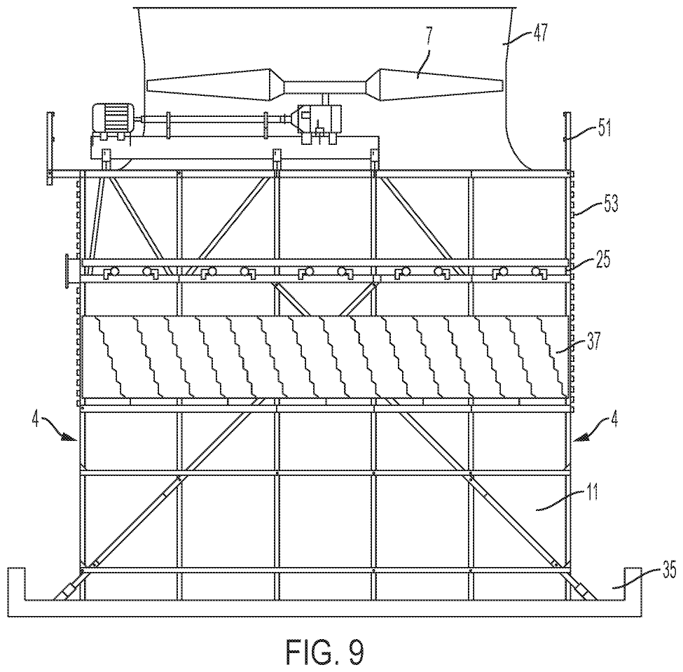

FIG. 9 shows an embodiment of the invention for use in locations where humidifiers are not necessary due to the normal humidity of the ambient air or where humidifiers are not economical due to a lack of water. According to this embodiment, no humidifiers are provided. The fan 7 draws ambient air directly into the plenum 11 of the reaction unit 3 up through a section of dense fill 37 and out the top of the unit. Reaction fluid distribution system 25 distributes the reaction fluid over the fill 37 and the resulting carbonate and unreacted reaction fluid and water fall into the reaction fluid basin 35. Louvers 9 are provided at air inlets 4 to the plenum 11, and cladding or other sheathing is provided around the exterior of the fill section and the fluid distribution section.

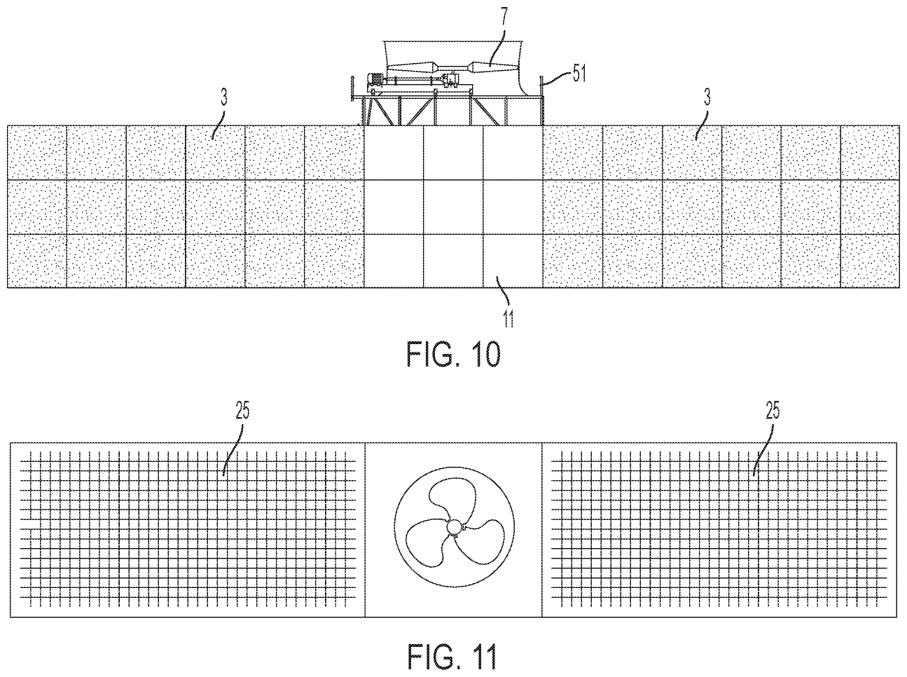

FIGS. 10 and 11 show another embodiment of the invention (elevation and plan views, respectively) for use in locations where humidifiers are not necessary or not economical due to shortage of water. As with the embodiment of FIG. 9, no humidifiers are provided in the embodiment of FIGS. 10 and 11. Where the reaction unit of FIG. 9 is directly below the fan, the reaction units 3 of the embodiment of FIGS. 10 and 11 flank the plenum 11.

The reaction fluid distribution system 25 is located at the top of the reaction units 3 which are loaded with dense fill 37, and the reaction fluid distribution system 25 distributes reaction fluid over the fill. Ambient air is drawn into and through the reaction units 3, into the plenum 11, and up through the top of the fan 7. The resulting carbonate and unreacted reaction fluid and water fall in to the basin below.

1. A carbon capture tower configured for large-scale and continuous removal of carbon dioxide from ambient air comprising:
a tower frame located above a reaction fluid basin,
a fluid dispersion medium supported in said tower frame;
a reaction fluid distribution system located in said tower frame and above said fluid dispersion medium and configured to distribute a reaction fluid over said fluid dispersion medium;
a fan supported by said tower frame and configured to draw or force ambient air through said fluid dispersion medium as said reaction fluid distribution system is distributing said reaction fluid over said fluid dispersion medium;
said reaction fluid basin located beneath said tower frame and configured to catch a reaction product from a reaction between said reaction fluid and carbon dioxide in said ambient air as well as unreacted reaction fluid.

2. A carbon capture tower according to claim 1, wherein said reaction fluid distribution system and said fluid dispersion medium are located beneath said fan.

3. A carbon capture tower according to claim 2, wherein said tower frame defines a plenum beneath a diameter of said fan, said carbon capture tower further comprising two humidifier sections of said tower frame flanking said plenum, said two humidifier sections each comprising water dispersion media supported in said frame and a saltwater distribution system located over said water dispersion media.

4. A carbon capture tower according to claim 1, wherein said tower frame defines a plenum beneath a diameter of said fan, and wherein said reaction fluid distribution system and said fluid dispersion medium are supported in a reaction portion of said tower frame that is laterally adjacent to said plenum.

5. A carbon capture tower according to claim 4, further comprising a humidifier section of said tower frame that is laterally adjacent to said reaction portion of said tower frame on a side of said reaction portion of said tower frame that is opposite said plenum, each said humidifier section of said tower frame comprising water dispersion media supported in said frame and a saltwater distribution system located over said water dispersion media.

6. A carbon capture tower according to claim 1, wherein said reaction fluid distribution system comprises a reaction fluid header connected to reaction fluid distribution pipes having spray nozzles connected thereto.

7. A carbon capture tower according to claim 1, wherein the reaction fluid is selected from the group consisting of sodium hydroxide, potassium hydroxide, and combinations thereof.

8. A carbon capture tower according to claim 1, wherein the tower frame, fan are fiberglass and the basins are hydroxide and carbonate corrosion resistant metal or reinforced concrete.

9. A carbon capture tower according to claim 1, wherein said fluid dispersion medium is film fill.

10. A carbon capture tower according to claim 9, wherein said film fill has a surface area to volume ratio of 124 square meters per cubic meter (38 ft²/ft³) or greater.

11. A carbon capture tower according to claim 10, wherein said film fill has a surface area to volume ratio of 210 m²/m³ (64 ft²/ft³) or greater.

12. A carbon capture tower according to claim 3 wherein said water dispersion medium is splash fill.
